(19) United States
(12) Patent Application Publication
(10) Pub. No.: US 2008/0189454 A1
(43) Pub. Date: Aug. 7, 2008

(54) Device For Transmitting Data

(76) Inventors: Metin Ersoy, Walluf (DE); Felix Haeusler, Osnabrueck (DE); Michael Klank, Osnabrueck (DE); Bernd Grannemann, Hille (DE); Armin Mueller, Rahden (DE); Joachim Spratte, Osnabrueck (DE)

Correspondence Address: MCGLEW & TUTTLE, PC, P.O. BOX 9227, SCARBOROUGH STATION, SCARBOROUGH, NY, 10510-9227, US

(21) Appl. No.: 11/574,187

(22) PCT Filed: Aug. 23, 2005
(86) PCT No.: PCT/DE05/01484

§ 371 Date: Sep. 17, 2007

(30) Foreign Application Priority Data
Aug. 24, 2004 (DE) 10 2004 041 085.2

(51) Int. Cl. G06F 13/42

(52) U.S. Cl. 710/106

(57) ABSTRACT

A device for data transmission for a motor vehicle is presented, which has sensors used for generating data. The sensors are arranged on or in chassis components occupying a variable position relative to the body of the motor vehicle. Furthermore, the device for data transmission has components or assembly units provided as rigid parts of the body for processing and/or evaluating the data generated in or on the chassis components occupying a variable position and a means for transmitting the data supplied by the sensors to said components, which are arranged as rigid parts of the body. The transmission means is designed according to the present invention as a plastic film web, which is provided with strip conductors and whose strip conductors establish a connection between interfaces provided on the chassis side and on the body side.

### CROSS REFERENCE TO RELATED APPLICATIONS

This application is a United States National Phase application of International Application PCT/DE2005/001484 and claims the benefit of priority under 35 U.S.C. § 119 of German Patent Application DE 10 2004 041 085.2 filed Aug. 24, 2004, the entire contents of which are incorporated herein by reference.

### FIELD OF THE INVENTION

The present invention pertains to a device for data transmission and more particularly pertains to data transmission for a motor vehicle, with sensors used for generating data, which are arranged on or in chassis components occupying a variable position relative to the body of the motor vehicle, with components or assembly units for processing and/or evaluating the data generated in or on the chassis components, as well as to a motor vehicle equipped with such a device.

### BACKGROUND OF THE INVENTION

Sensors, which detect data corresponding to the profile of requirements imposed on them in order to increase, for example, the driving smoothness or the safety of the motor vehicle, are increasingly used in motor vehicles to determine motor vehicle- or pavement-specific data.

The sensors present on or in chassis components occupying a variable position relative to the body of the motor vehicle generate data that are sent to at least one central processing unit in order to be processed there. Depending on the amount of data or the type of data, evaluating units may, moreover, be provided. However, these components or assembly units for processing and/or evaluating the data generated in or on the chassis components occupying variable positions, which said components or assembly units are rigidly connected to the body, must also be supplied with the detected signals, so that at least one transmission means is necessary for data transmission in every case. For example, if data are detected in an area close to the wheel, the electronic components and especially the transmission means are exposed to considerable thermal, mechanical and/or chemical effects. In addition, it is necessary to guide the transmission means along mobile components or assembly units. They must have just as flexible a design for this purpose as their connection areas, i.e., the interfaces, since spontaneous separation or destruction of the connection between the sensor and the processing unit may lead to considerable impairments or represent a safety-relevant risk.

Transmission means known up to now are either susceptible to wear or inflexible and therefore cannot sufficiently follow the motions of the chassis components, some of which are high-frequency motions.

Solutions in which wires are installed as transmission means within chassis components are known as well. This type of data transmission is disadvantageous in several respects. On the one hand, the chassis component must have an inlet opening and an outlet opening for the transmission means, which means a weakening of the cross section. On the other hand, there is a risk that the inlet or outlet opening has leaky points, so that the chassis component itself may be subject to corrosion or dirt may penetrate into the chassis component. Furthermore, especially complicated insulation measures must be taken in the area of the inlet and outlet openings to protect the transmission means against mechanical damage or to avoid short-circuits.

### SUMMARY OF THE INVENTION

The basic object of the present invention is to provide a device for data transmission that is resistant to wear and makes possible the simple and reliable transmission of the detected data even along moving chassis components, as well as to propose an application of such a device.

According to the invention, a device is provided for data transmission for a motor vehicle, with sensors used for generating data, which are arranged on or in chassis components occupying a variable position relative to the body of the motor vehicle. Components or assembly units are provided for processing and/or evaluating the data generated in or on said chassis components. These components or assembly units are provided as rigid parts of the body. A transmission means is employed as a plastic film web, provided with strip data/communication conductors. These strip conductors establish a connection between interfaces provided on the chassis side and on the body side.

Due to its flexibility, the plastic film web is able to follow the motions of the chassis components, some of which are high-frequency motions, without being damaged themselves in the process. Moreover, it can also be led over hinge sections and installed at poorly accessible points without great effort. Depending on the provision with strip conductors, nearly any desired amount of data can be transmitted. Electric conductors can be used as strip conductors just as well as optical or other conductors.

According to one embodiment of the present invention, it is considered to be advantageous if the interfaces are embodied in the form of plug type connectors. A simple possibility is thus created for establishing or interrupting a connection for data transmission. This may be necessary, for example, when a chassis component must be repaired or replaced.

To avoid the unintended spontaneous separation of such an interface with plug type connectors, the plug type connectors may, furthermore, have means securing them against separation.

Since the device for data transmission according to the present invention will be used predominantly, albeit not exclusively, for motor vehicles, it is meaningful to provide for protection against the above-mentioned thermal, mechanical and/or chemical effects. This can be carried out, for example, by the plastic film web having a protective layer lying on the outside or a protective cover, which may consist of an elastomeric material according to another embodiment.

Another advantage of a flexible plastic film web can be seen in the fact that this web can be installed along the chassis components or can be integrated in the chassis component during the manufacture at least partially, i.e., for example, embedded in same.

A very simple possibility of fastening for a plastic film web according to the present invention to a chassis component can also be seen in that the plastic film web has recesses or openings, which mesh with the fastening elements for fastening the plastic film web to the chassis components or to components or assembly units that are rigid parts of the body.

It is likewise possible to provide a non-positive connection for fixing the plastic film web to the chassis components or components or assembly units that are a rigid part of the body.

If the chassis components, whose position relative to the body of the motor vehicle is variable, are wheel guide elements or spring components, the plastic film web can be installed in a very simple and hence inexpensive manner in a depression or recess of the wheel guide elements or spring components, which likewise offers an additional protection for the plastic film web.

It is possible due to another embodiment of the present invention to process data that were generated or detected by the sensors and thus to perform, for example, a selection and, if necessary, a reduction of the data to be sent for transmission to the central processing unit (CPU). This can be carried out by a processor present on or in chassis components occupying a variable position relative to the body of the motor vehicle.

Besides data transmission, further possibilities of application are available for the transmission means designed as a flexible plastic film web. Thus, it is possible, corresponding to a further idea of the present invention, to also use the plastic film web for transmitting energy or to use it exclusively to transmit energy. It would thus be possible not only to transmit measured signals, but, if necessary, also to additionally supply electronic assembly units or components with energy. The term “energy” is, however, not limited here to electric power supply. The energy may also represent other forms of energy here. The conductor is at least a conductor of data.

The device for data transmission according to the present invention can be used in an especially meaningful manner in a motor vehicle with chassis components, components or assembly units provided as rigid parts of the body and with a data flow taking place between the chassis components and the components or assembly units provided as rigid parts of the body.

A preferred, special embodiment variant of a device for data transmission according to the present invention will be described below on the basis of Figure. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic perspective view showing a connection between a chassis component and the motor vehicle body;

FIG. 2 is a schematic showing of the motor vehicle with chassis components and related system features.

### DESCRIPTION OF THE PREFERRED EMBODIMENTS

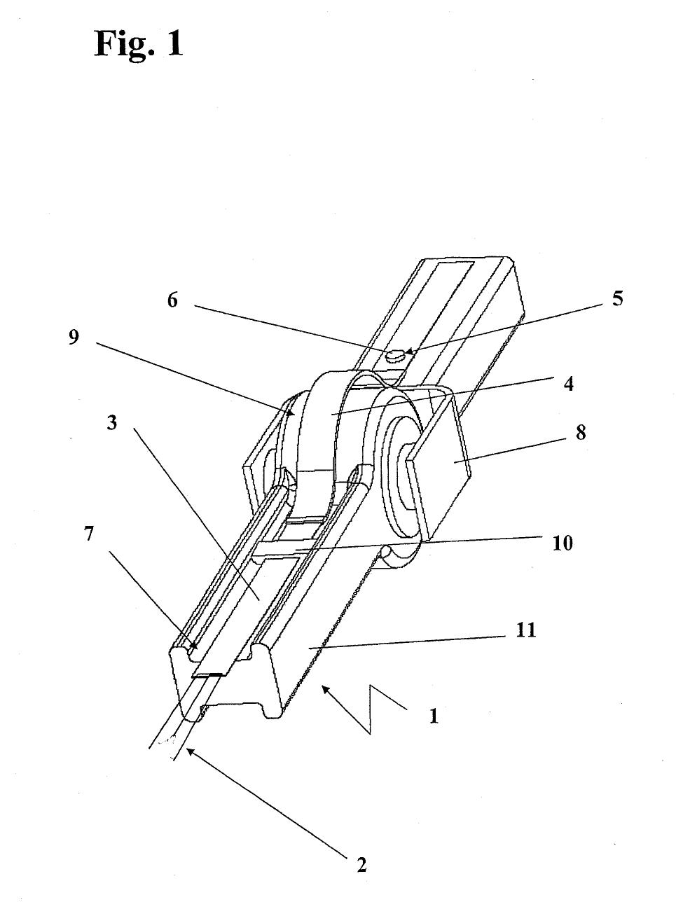

Referring to the drawings in particular, the chassis component 1 shown in FIG. 1 is a suspension arm, which establishes a connection between the vehicle wheel and the vehicle body. On the end side, this suspension arm 1 has a bearing element 9, which establishes an articulated connection to a fork 8 of a subframe. The suspension arm 1 has a section facing away from the joint with a double T-shaped cross section, so that recesses or depressions 7, which can be used to arrange a plastic film web 3 according to the present invention, are formed as a result on two sides of the suspension arm 11, which sides are located opposite each other. A plurality of strip conductors 2, which are used for the data transmission, are embedded in the plastic film web 3 in the exemplary embodiment being shown. The plastic film web 3 can be fastened to the suspension arm 1 or to other components in various manners. FIG. 1 shows a first possibility of fastening, in which a fastening element 6, which thus fixes the plastic film web 3 in a non-positive or positive-locking manner, is led through a recess 5 in the plastic film web 3.

Another possibility of fastening, which is shown in the front part of FIG. 1, is to hold the plastic film web 3 by means of a strap 10, which is inserted into the depression 7 of the suspension arm 1. To protect the plastic film web 3 against mechanical, thermal and/or chemical effects, a protective layer 4 is provided, which is shown in the form of a suggestion only, and which was made of rubber here and forms a protective cover of the plastic film web 3.

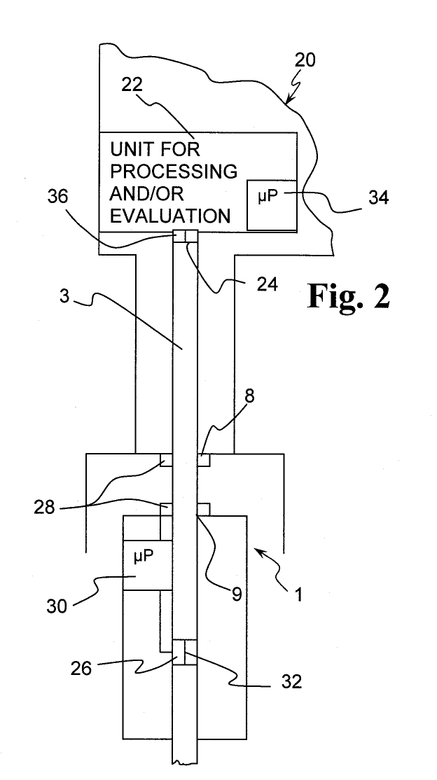

FIG. 2 shows the motor vehicle with chassis components in a schematic view. The chassis component 1 includes one or more sensors 28, supplying data to the transmission means with plastic film web 3. The transmission means supplies the data from the chassis component 1 to the components or assembly units 22 for processing and/or evaluating the data. The unit 22 is mounted to or provided as a rigid part of the vehicle body generally designated 20. The strip conductors 2 of the transmission means establish a connection between a body side interface via a plug 24 and a chassis side interface via a plug 26. Plug type connectors 24 and 26 may have a latch or means 32 and 36 for securing the plug connectors 24 and 26 against separation from the respective body side interface and chassis side interface. The chassis component 1 has a processor 30 which may be used for selecting and/or sending data to a computing unit 34 connected to the vehicle body 20.

While specific embodiments of the invention have been shown and described in detail to illustrate the application of the principles of the invention, it will be understood that the invention may be embodied otherwise without departing from such principles.

1. A device for data transmission for a motor vehicle, with sensors used for generating data, which are arranged on or in said chassis components occupying a variable position relative to the body of the motor vehicle, with components or assembly units for processing and/or evaluating the data generated in or on said chassis components occupying variable positions, which said components or assembly units are provided as rigid parts of the body, the device comprising:
a transmission means for transmission of the data supplied by the sensors to the components or assembly units arranged as rigid parts of the body, said transmission means comprising a plastic film web and strip conductors of data providing a data connection between interfaces provided on the chassis side and on the body side.

2. A device for data transmission in accordance with claim 1, wherein said interfaces are embodied by plug type connectors.

3. A device for data transmission in accordance with claim 2, wherein said plug type connectors have a means securing them against separation.

4. A device for data transmission in accordance with claim 1, wherein said plastic film web has a protective layer located on the outside or a protective cover.

5. A device for data transmission in accordance with claim 4, wherein said protective layer or protective cover consists of an elastomeric material.

6. A device for data transmission in accordance with claim 1, further comprising:
fastening elements, wherein said web includes recesses or openings engaging said fastening elements for fastening said plastic film web to said chassis components or components or assembly units which are a rigid part of the body.

7. A device for data transmission in accordance with claim 1, wherein said plastic film web is fastened to said chassis components or components or assembly units which are a rigid part of the body by a non-positive connection.

8. A device for data transmission in accordance with claim 1, wherein the chassis components occupying variable positions relative to the body of the motor vehicle are wheel guide elements or spring components.

9. A device for data transmission in accordance with claim 8, wherein said plastic film web extends in a depression or recess of said wheel guide elements or spring components.

10. A device for data transmission in accordance with claim 1, wherein at least one processor for processing, selecting and/or sending data to a computing unit that is a rigid part of the body is present on or in said chassis components that occupy a variable position relative to the body.

11. A device for data transmission in accordance with claim 1, wherein the device for data transmission is or has a means for transmitting energy.

12. A motor vehicle comprising:
a vehicle body;
chassis components with sensors and chassis side communication interfaces;
components or assembly units with body side communication interfaces the components or assembly units connected to the body;
a transmission means for transmission of the data supplied by the sensors to the components or assembly units, said transmission means comprising a plastic film web and strip conductors to establish a data connection between the interfaces provided on the chassis side and on the body side.

13. A motor vehicle data transmission system comprising:
a vehicle body;
a chassis component mounted for movement relative to said vehicle body, said chassis component having a sensor and a chassis component interface;
a body unit with a body unit interface, said body unit being mounted to said vehicle body;
a transmission means comprising a plastic film web and strip data conductors to establish a data connection between said chassis component interface and said body unit interface.

14. A system in accordance with claim 13, wherein said chassis component interface comprises a plug connector.

15. A system in accordance with claim 14, wherein said plug connector has a securing feature to secure against separation of said chassis plug connector and said chassis component interface.

16. A system in accordance with claim 13, wherein said plastic film web has a protective outer layer comprising an elastomeric material.

17. A system in accordance with claim 13, wherein said chassis component has a portion with a depression or recess, wherein said plastic film web is disposed therein.

18. A system in accordance with claim 13, further comprising:
fastening elements, wherein said web includes recess or opening engaging said fastening elements for fastening said plastic film web to said chassis component.

19. A system in accordance with claim 13, further comprising a processor for processing, selecting and/or sending data to a computing unit of said body unit.

20. A system in accordance with claim 13, wherein said transmission means includes means for transmitting energy.
